(19) United States
(12) Patent Application Publication
(10) Pub. No.: US 2012/0274656 A1
(43) Pub. Date: Nov. 1, 2012

(54) CONTROLLING DISPLAY SETTING ACCORDING TO EXTERNAL DEVICE CONNECTED TO USER EQUIPMENT

(76) Inventors: You-Jin KANG, Seoul (KR); Shin-Hyuk KANG, Seoul (KR); Jae-Hun JUNG, Gyeonggi-do (KR); Jae-Uk CHA, Gyeonggi-do (KR)

(21) Appl. No.: 13/460,091

(22) Filed: Apr. 30, 2012

(30) Foreign Application Priority Data
Apr. 29, 2011 (KR) 10-2011-0041165
Mar. 16, 2012 (KR) 10-2012-0027316

(51) Int. Cl. G09G 5/00

(52) U.S. Cl. 345/619; 345/156

(57) ABSTRACT

Provided is controlling a display setting according to an external device connected to user equipment. Such controlling may include displaying image data on a first display unit of the user equipment based on a first display setting, sensing a connection between the user equipment and the external device, obtaining display unit information from the external device, determining the second display setting based on the obtained display unit information, reconfiguring the image data according to the determined second display setting, and displaying the reconfigured image data on a second display unit of the external device based on a presence of the sensed connection.

### CROSS REFERENCE TO PRIOR APPLICATIONS

The present application claims priority under 35 U.S.C. §119 to Korean Patent Application No. 10-2011-0041165 (filed on Apr. 29, 2011) and Korean Patent Application No. 10-2012-0027316 (filed on Mar. 16, 2012), which are hereby incorporated by reference in their entireties.

### FIELD OF THE INVENTION

The present invention relates to communications and in particular, to controlling display setting according to an external device connected to user equipment.

### BACKGROUND OF THE INVENTION

User equipment has advanced so as to perform multiple functions such as communicating voice and data with others; exchanging text messages or multimedia messages; sending e-mails; capturing a still or moving image; playing back a music or a video file, playing a game, and a receiving a broadcast signal. Lately, such multi-functional user equipment has received greater attention for new applications. Instead of using multiple independent devices, a user prefers to use single multifunction-enabled user equipment. Portability and/or mobility should be considered in design of user equipment, but such user equipment has limitations in size. Accordingly, there also are limitations in display screen size, screen resolution, and speaker performance.

In order to overcome such limitations, an external device having a large display size, better speaker performance, and connectable to a mobile terminal has been introduced. Such external device connected to the mobile terminal can provide data, music files, and other content stored in the mobile terminal in better performance. Accordingly, there is a demand for developing technologies in hardware and software to support interactions between the mobile terminal and the connected external device.

### SUMMARY OF THE INVENTION

This summery is provided to introduce a selection of concepts in a simplified form that are further described below in the detailed description with reference to the drawings. This summary is not intended to identify key features or essential features of the claimed subject matter, nor is it intended to limit the scope of the claimed subject matter. Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, user equipment may display image data on a display unit of an external device when the user equipment is connected to the external device.

In accordance with another aspect of the present invention, user equipment may control a display setting according to a display unit of an external device when the user equipment is connected to the external device.

In accordance with still another aspect of the present invention, user equipment may control a dot per inch (DPI) value determined for an external device when the user equipment is connected to the external device.

In accordance with further still another aspect of the present invention, user equipment en may display a graphic user interface on a display unit of an external device with a screen layout determined for the display unit of an external device when the user equipment is connected to the external device.

In accordance with further still another aspect of the present invention, in response to a request for display unit information of a display unit displaying image data, user equipment may provide display unit information of the user equipment regardless of whether the user equipment is connected to an external device.

In accordance with further still another aspect of the present invention, user equipment may restore a DPI value of the user equipment although it is changed due to connection to an external device when an activated application does not dynamically provides a graphic user interface in real time according to a display unit that displays the graphic user interface.

In accordance with an embodiment of the present invention, a method may be provided for controlling a display setting at user equipment connected to an external device. The method may include displaying image data on a first display unit of the user equipment based on a first display setting, sensing a connection between the user equipment and the external device, obtaining display unit information from the external device, determining the second display setting based on the Obtained display unit information, reconfiguring the image data according to the determined second display setting, and displaying the reconfigured image data on a second display unit of the external device based on a presence of the sensed connection.

The determining the second display setting may include extracting a screen size and a screen resolution of the second display unit from the obtained display unit information, selecting a dots per inch (DPI) value from a DPI table based on the extracted screen size and the extracted screen resolution of the second display unit, and determining the second display setting based on the selected DPI value. The DPI table may include a plurality of DPI values associated with a plurality of screen sizes and screen resolutions.

The reconfiguring the image data may include determining a screen layout based the selected DPI value included in the second display setting and reconfiguring the image data with the determined screen layout.

The reconfiguring the image data may include updating, by an application framework, a default DPI value included in system configuration information with the selected DPI value, wherein the default DPI value is a DPI vale determined for the user equipment before the connection, notifying, by the application framework, of applications that the system configuration information is updated with the selected DPI value, determining, by the applications, a screen layout based on the selected DPI value, and producing the image data., by the applications, with the determined screen layout.

The method may further include activating the second display unit of the external device after sensing the connection between the user equipment to the external device, transmitting the reconfigured image data to external device through the connection between the user equipment and the external device, and controlling the external device to display the reconfigured image data through the second display unit.

The method may further include sensing an absence of the connection between the user equipment and the external device, activating the first display unit of the user equipment, restoring the first display setting, and displaying the image data on the first display unit based on the restored first display setting.

The restoring the first display setting may include updating, by an application framework, an updated DPI value in system configuration information with a default DPI value, wherein the updated DPI value is a DPI value determined for the external device after the connection and the default DPI value is a DPI value determined for the user equipment before the connection, notifying, by the application framework, of applications that the system configuration information is updated with the default DPI value, determining, by the applications, a screen layout based on the default DPI value, and producing the image data, by the applications, with the determined screen layout.

The first display setting and the second display unit may include at least one of a screen size, a screen resolution, a display direction and a DPI value. The display unit information may include at least one of a manufacturer, a model number, a device identifier (ID), a DPI value, a screen size, screen resolutions, aspect ratios, refresh rates, and response times. The reconfiguring the image data may include reconfiguring at least one of the screen size, the screen resolution, the display direction, and the DPI value based on the obtained display unit information.

The method may further include receiving a request for display unit information from an application after the connection and providing the display unit information of the user equipment.

The providing the display unit information may include determining whether the application dynamically provide a graphic user interface in real tune according to the display unit information, providing the display unit information of the external device when the application dynamically provide a graphic user interface according to the display unit information, and otherwise, providing the display unit information of the user equipment.

The method may further include determining whether an activated application dynamically provides a graphic user interface according to change of a display unit when an application is activated after the sensing a connection between the user equipment and the external device, maintaining an updated DPI value included in system configuration information when the activated application dynamically provides a graphic user interface according to change of a display unit, wherein the updated DPI value is a DPI value determined for the external device after the connection, changing the updated DPI value included in system configuration information to a default DPI value when the activated application does not dynamically provide a graphic user interface according to change of a display unit, wherein the default DPI value is a DPI value determined for the user equipment before the connection, and changing the default DPI value back to the updated DPI value in the system configuration information when the application becomes inactivated.

The determining the second display setting may include determining a device identifier (ID) from the obtained display unit information of the second display unit, and obtaining a DPI value corresponding to the second display unit based on the determined device ID. The image data may be reconfigured based on a screen layout determined by the obtained DPI value.

In accordance with another embodiment of the present invention, user equipment may be provided for controlling a display setting according to an external device connected to the user equipment. The user equipment may include a first display unit, a port unit, and a controller. The first display unit may be configured to display image data based on a first display setting. The port unit may be configured to be connected to the external device, to sense whether the user equipment is connected to the external device, and to generate a connection signal or a disconnection signal based on the sensing result. The controller may be configured to activate the external device when receiving the connection signal from the port unit, to obtain display unit information from the external device, to determine a second display setting based on the obtained display unit information, to reconfigure the image data according to the determined second display setting, to transmit the reconfigured to the external device through the pot unit, and to control the external device to display the reconfigured image data on a second display unit of the external device based on a presence of the sensed connection.

The user equipment may further include a memory configured to store a dots per inch (DPI) table including a plurality of DPI values associated with a plurality of screen sizes and screen resolutions In this case, the controller may be configured to extract a screen size and a screen resolution of the second display unit from the obtained display unit information, select a dots per inch (DPI) value from a DPI table based on the extracted screen size and the extracted screen resolution of the second display unit, determine a screen layout based the selected DPI value, and reconfigure the image data with the determined screen layout.

The controller may be configured to update a default DPI value included in system configuration information with the selected DPI value through an application framework. The default DPI value may be a DPI vale determined for the user equipment before the user equipment is connected to the external device. After notification, the controller may be configured to notify of applications that the system configuration information is updated with the selected DPI value. In response to the notification, the application may determine a screen layout based on the selected DPI value and produces the image data with the determined screen layout.

The controller configured to activate the first display unit upon the receipt of the disconnection signal and update, through an application framework, an updated DPI value in system configuration information with a default DPI value. The updated DPI value may be a DPI value determined for the external device after the connection and the default DPI value may be a DPI value determined for the user equipment before the connection. After update, the controller may notify, through the application framework, of applications that the system configuration information is updated with the default DPI value. The controller may receive, from the applications, image data produced with a screen layout based on the default DPI value and control the first display unit to display the received image data.

The first display setting and the second display unit may include at least one of a screen size, a screen resolution, a display direction and a DPI value. The display unit information may include at least one of a manufacturer, a model number, a device identifier (ID), a DPI value, a screen size, screen resolutions, aspect ratios, refresh rates, and response times. In this case, the controller may be configured to control at least one of the screen size, the screen resolution, the display direction, and the DPI value based on the obtained display unit information and to display the image data based on the controlled at least one of the screen size, the screen resolution, the display direction, and the DPI value.

The controller may be configured to receive a request for display unit information from an application after the user equipment is connected to the external device and provide the display unit information of the user equipment to the application through an application framework.

The controller may be also configured to determine whether the application dynamically provide a graphic user interface in real time according to the display unit information, provide the display unit information of the external device when the application dynamically provide a graphic user interface according to the display unit information, and otherwise, provide the display unit information of the user equipment.

The controller may be configured to determine whether an activated application dynamically provides a graphic user interface according to change of a display unit when an application is activated after the user equipment is connected to the external device. When the activated application dynamically provides a graphic user interface according to change of a display unit, the controller may maintain an updated DPI value included in system configuration information. The updated DPI value may be a DPI value determined for the external device after the connection. When the activated application does not dynamically provide a graphic user interface according to change of a display unit, the controller may change the updated DPI value included in system configuration information to a default DPI value. The default DPI value may be a DPI value determined for the user equipment before the connection. When the application becomes inactivated, the controller may be configured to change the default DPI value back to the updated DPI value in the system configuration information.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1A shows user equipment in accordance with an embodiment of the present invention;

FIG. 1B shows an external device in accordance with an embodiment of the present invention;

FIG. 2 shows user equipment coupled to an external device in accordance with an embodiment of the present invention;

FIG. 3 shows various manner of connecting user equipment and an external device;

FIG. 4 shows user equipment in accordance with an embodiment of the present invention;

FIG. 5 is a block diagram illustrating external device in accordance with an embodiment of the present invention;

FIG. 6 shows a port unit of user equipment in accordance with an embodiment of the present invention;

FIG. 7 shows an operating system architecture in accordance with an embodiment of the present invention;

FIG. 8 shows a dots per inch (DPI) table in accordance with an embodiment of the present invention;

FIG. 9 shows a method for controlling display setting information according to an external device connected to user equipment in accordance with an embodiment of the present invention;

FIG. 10 shows a method for controlling a DPI value according to an external device when user equipment is connected to the external device in accordance with an embodiment of the present invention;

FIG. 11 shows a method for controlling a DPI value according to an external device connected to user equipment when the user equipment is disconnected from the external device in accordance with an embodiment of the present invention;

FIG. 12 shows a first graphic user interface displayed on user equipment and an external device in accordance with an embodiment of the present invention;

FIG. 13 shows a second graphic user interface displayed on user equipment and an external device in accordance with an embodiment of the present invention;

FIG. 14 shows a method for controlling a display setting according to an external device connected to user equipment in accordance with another embodiment of the present invention; and

FIG. 15 shows a method for controlling display setting information according to an external device connected to user equipment in accordance with another embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

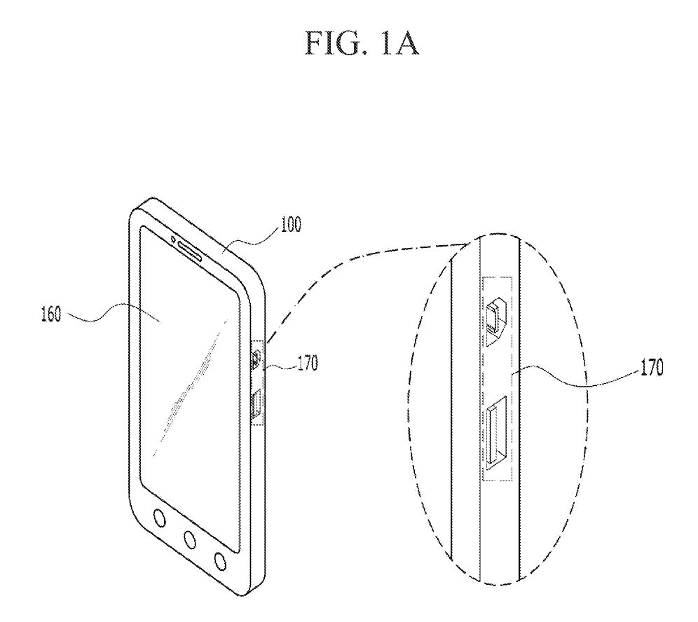

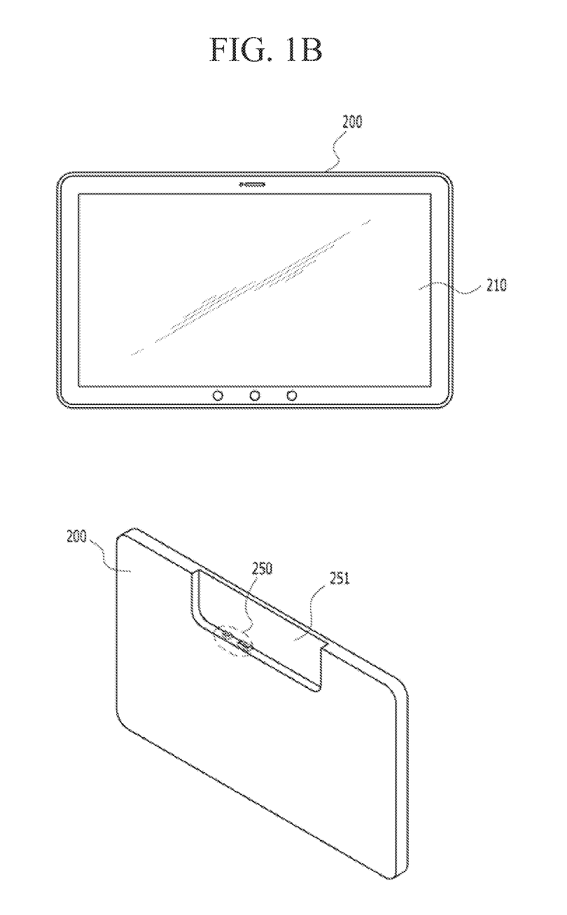

FIG. 1A shows user equipment and FIG. 1B shows an external device in accordance with an embodiment of the present invention.

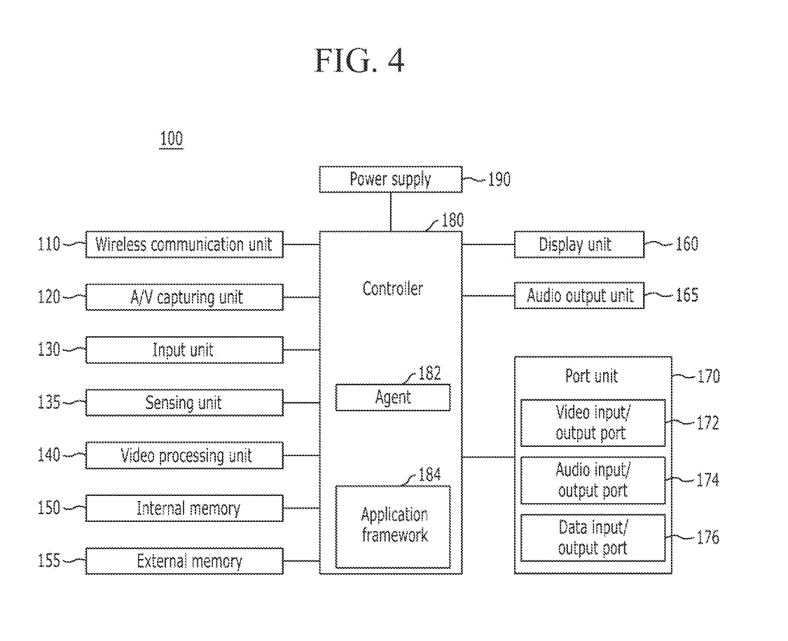

Referring to FIG. 1A, user equipment 100 may include display unit 160 and at least one port unit 170. Display unit 160 may display data according to display setting of user equipment 100. Display unit 160 may typically have about 4.5 inch display area which is smaller than that of external device 200, but the present invention is not limited thereto. For example, a display area of external device 200 may be smaller than that of user equipment 100. At least one port unit 170 may be coupled to external device 200 and exchange data. User equipment 100 may be capable of processing data, displaying the processed data on display unit 160, and transferring the processed data to an external device through port unit 170. Particularly, user equipment 100 may process image data corresponding to a display setting of display unit 160 and display the processed image data on display unit 160. In accordance with an embodiment of the present invention, user equipment 100 may be capable of i) adjusting the processed image data according to a display setting of external device 200, ii) transferring the adjusted image data to external device 200 through the at least one port unit 170, and ii) controlling the display unit of external device to display the adjusted image data. As described above, user equipment 100 may include at least one port unit 170. Such a port unit 170 may include a high definition multimedia interface (HDMI) port and/or a universal serial bus (USB) port, but the present invention is not limited thereto. User equipment 100 may have a certain design or standardized interface connectable to external device 200. For example, user equipment 100 may be attachable to and/or detachable with a cable or wireless radio from external device 200. User equipment 100 may dock to external device 200. User equipment 100 may be any electronic device that can perform the above and further operations described herein. For example, user equipment 100 may include, but is not limited to, a mobile terminal, a mobile device, a mobile phone, a portable terminal, a portable device, a handheld device, a cellular phone, a smart phone, a personal digital assistant (PDA), wireless local loop (WLL) station, a portable multimedia player (PMP), and a navigation device. The present invention, however, is not limited thereto, and other types of user equipment, such as mini-laptop PCs and other computing devices may incorporate embodiments of the present invention. User equipment 100 will be described in more detail with reference to FIG. 4.

As shown in FIG. 1B external device 200 may include display unit 210 and at least one pot unit 250. Display unit 210 may display data. Display unit 210 may have a display area larger than that of user equipment 100. For example, display unit 210 may have about 10.1 inch of display area. The present invention, however, is not limited thereto. External device 200 may have a display area smaller than that of user equipment 100. At least one port unit 250 may be coupled to corresponding port unit 170 of exchanging data with user equipment 100. Accordingly, at least one port unit 250 may include a HDMI port and/or a USB port corresponding to port unit 170 of user equipment 100. External device 200 may be capable of receiving data from user equipment 100 through at least one port unit 250 and displaying the received data on display unit 210. External device 200 may have a certain design connectable to user equipment 100 through at least one port unit 250. For example, external device 200 may be attachable to and/or detachable from user equipment 100 as described above with respect to FIG. 1A. External device 200 may have a structure for receiving and holding user equipment 100. Such a structure may be referred to as coupling bay 251. External device 200 may be any electronic device that can perform the above operation. For example, external device 200 may include a notebook computer, a laptop computer, a tablet PC, a pad having a touch screen, and a pad having a display unit and a keyboard, but the present invention is not limited thereto. In accordance with an embodiment of the present invention, external device 200 may be activated when user equipment 100 is connected to external device 200 and controlled by user equipment 100. Accordingly, external device 200 may have at least constituent elements for necessary operation performed under the control of user equipment 100.

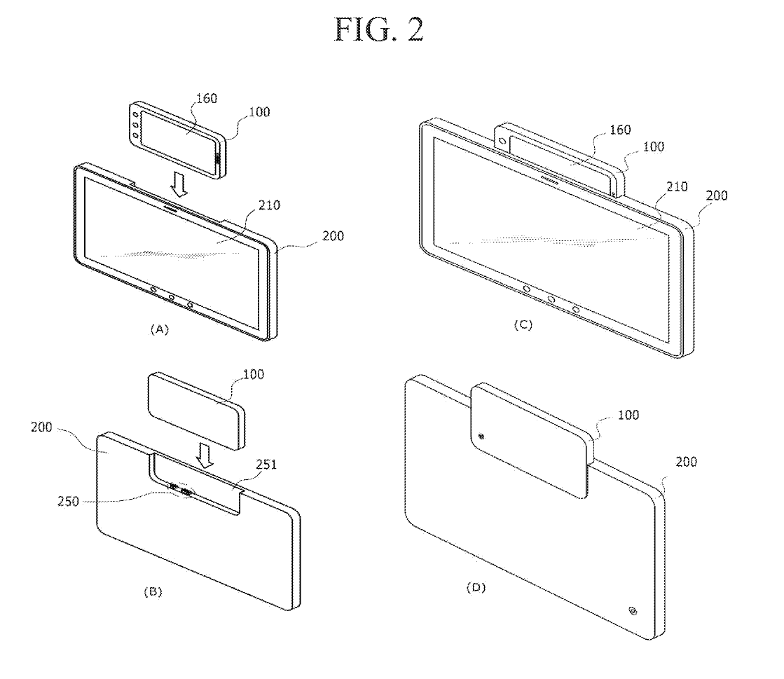

As described above, user equipment 100 may be coupled to external device 200. For example, at least one port unit 170 of user equipment 100 may be coupled to at least one port unit 250 of external device 200. In accordance with an embodiment of the present invention, user equipment 100 may be coupled to external device 200 in a docking manner. Such coupling manner will be described with reference to FIG. 2.

FIG. 2 shows user equipment coupled to an external device in accordance with an embodiment of the present invention.

Referring to FIG. 2, user equipment 100 may be inserted in coupling bay 251 of external device 200 in a top-to-bottom direction as shown in a diagram (A). As shown in diagram (B), display unit 160 of user equipment 100 and display unit 210 of external device 200 may face the same direction while user equipment 100 is inserted into coupling bay 251 of external device 200. As shown in diagram (C), user equipment 100 may be completely inserted into coupling bay 251 of external device 200 until at least one port unit 170 of user equipment 100 is interlocked to at least one port unit 250 of external device 200. Although FIG. 2 shows that user equipment 100 is coupled with external device 200 in a docking manner, the present invention is not limited thereto. User equipment 100 may be coupled to external device 200 in other manners.

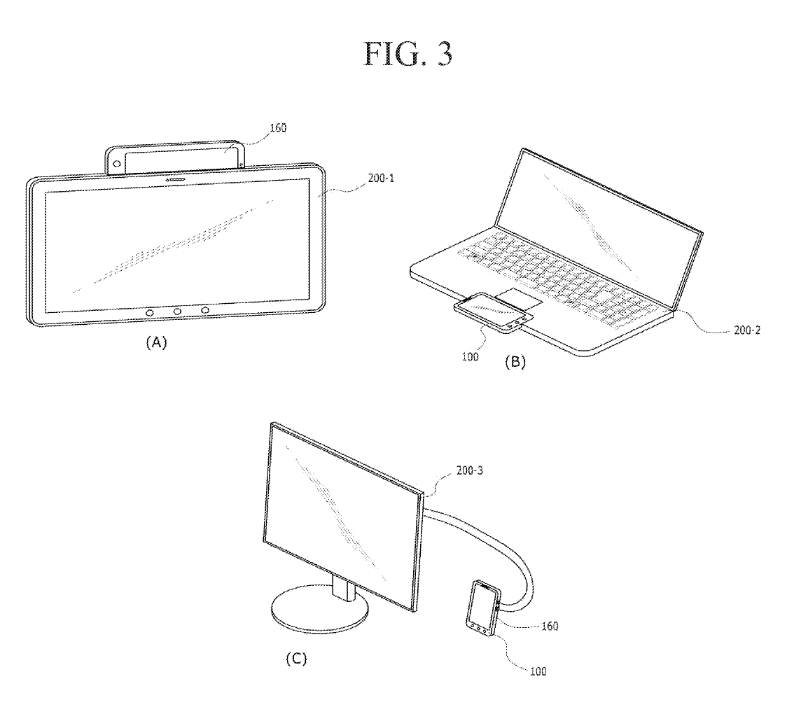

FIG. 3 shows various coupling manners of user equipment and an external device.

Referring to FIG. 3, user equipment 100 may be coupled to a pad type device 200-1 in a docking manner as show in a diagram (A). Furthermore, user equipment 100 may be coupled to a laptop computer 200-2 in a docking manner as show in a diagram (B). User equipment 100 may be coupled to a monitor 200-3 through a physical cable as shown in a diagram (C).

As shown, user equipment 100 may be coupled o external device 200 in various manners. After user equipment 100 is coupled to external device 200, user equipment 100 may exchange data with external device 200 through port units 170 and 250. In accordance with an embodiment of the present invention, user equipment 100 may control external device 200 by exchanging data through a communication link formed between port unit 170 of user equipment 100 and port unit 250 of external device 200. Particularly, user equipment 100 may adjust image data according to a display setting of display unit 210 of external device 200, transfer the adjusted image data to external device 200 through port units 170 and 250, and control display unit 210 of external device 200 to display the adjusted image data in accordance with an embodiment of the present invention.

Hereinafter, user equipment 100 will be described in more detail with reference to FIG. 4. As described above, user equipment 100 may be coupled to external device 200 and control external device 200 in accordance with an embodiment of the present invention. Particularly, user equipment 100 may display image data on a display unit of external device 200 after user equipment 100 is connected to external device. In order to properly display the image data including a graphic user interface, user equipment 100 may control a display setting based on display unit information of external device 200 in accordance with an embodiment of the present invention.

FIG. 4 shows user equipment in accordance with an embodiment of the present invention.

Referring to FIG. 4, user equipment 100 may include wireless communication unit 110, audio/video (A/V) input unit 120, input unit 130, sensing unit 135, video processing unit 140, internal memory 150, external memory 155, display unit 160, audio output unit 165, a port unit 170, a controller 180, and a power supply 190. Controller 180 may include an agent 182 and application framework 184. Port unit 170 may include video input/output port 172, audio input/output port 174, and data input/output port 176. Power supply unit 190 may include a battery for electric charging. User equipment 100 may be described as including the above constituent elements, but the present invention is not limited thereto.

Wireless communication unit 110 may include at least one module for communicating with other party through a wireless communication system. For example, wireless communication unit 110 may include any or all of a broadcasting signal receiving module, a mobile communication module, a wireless Internet module, a short-distance communication module, and a location information module. In accordance with an embodiment of the present invention, wireless communication unit 110 may be not an essential unit for user equipment 100 because user equipment 100 may be not required to communicate with another party. Accordingly, wireless communication unit 110 may be omitted in accordance with another embodiment of the present invention.

A/V capturing unit 120 may capture an audio signal and/or a video signal. For example, the A/V input unit 120 may include a camera and a microphone. The camera may process image frames of a still image or a moving image, which are captured by an image sensor in a video call mode or a photographing mode. The microphone may receive an audio signal provided externally in an on-call mode, a recording mode, or a voice recognition mode.

Input unit 130 may be a user interface for receiving input from a user. Such an input unit 130 may be realized in various types. For example, input unit 130 may include any of a keypad, a dome switch, a touch pad, a jog wheel, and a jog switch, but is not limited thereto.

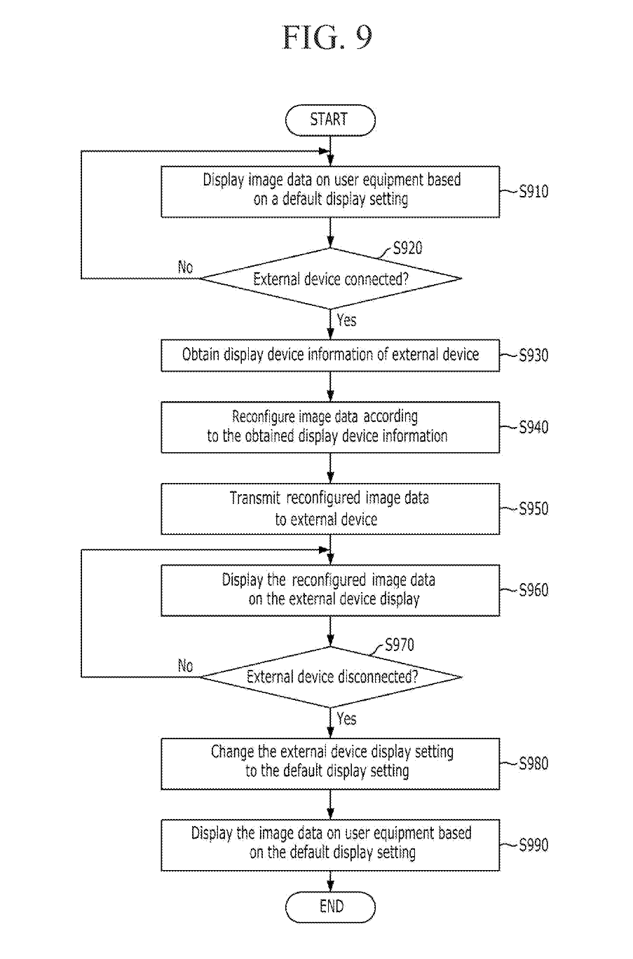

Sensing unit 135 may detect a current status of user equipment 100. For example, sensing unit 135 may sense an opening or closing of a cover of user equipment 100, a location and a bearing of user equipment 100, acceleration and deceleration of user equipment 100, or physical contact with or proximity to a user. Based on the detected status of user equipment 100, sensing unit 135 may generate a sensing signal to control the operation of user equipment 100. For example, in the case of a mobile phone having a sliding type cover, sensing unit 135 may sense whether a cover is opened or closed. Sensing unit 135 may sense whether or not power supply 190 supplies power. Furthermore, sensing unit 135 may sense whether or not port unit 170 is coupled to external device 200. In this case, sensing unit 135 may receive a detection signal from port unit 170 when user equipment 100 is connected to external device 200 in accordance with an embodiment of the present invention. For example, sensing unit 135 may receive a detection signal from a hot plug detect (HPD) pin when port unit 170 includes a HDMI port. Based on the detection signal, controller 160 may determine that external device 200 is connected to user equipment 100. Upon the receipt of such signal, user equipment 100 may initiate interrupting displaying image data on display unit 160 and starting displaying the image data on external device 200. Such operation will be described in detail with reference to FIG. 9 to FIG. 15.

Video processing unit 140 may process an signal and/or image data tau under the control of controller 160. Particularly, video processing unit 140 may process image data according to a display setting determined based on display unit information of display unit 160. The display setting may include a screen size, a screen resolution, a display direction, and a dot per inch (DPI) value. The display setting may be determined by controller 180 based on display unit information of display unit 160. The display unit information may include a manufacturer, a model number, a device identifier (ID), a DPI value, a screen size, the number of pixels, supporting screen resolutions, supporting aspect ratios, refresh rates, and a response time. Video processing unit 140 may transmit the processed image data to display unit 160 of user equipment 100 in response to controller 160. Furthermore, video processing unit 140 may process image data to be transmitted to external device 200 when user equipment 100 is connected to external device 200. For example, video processing unit 140 may, reconfigure image data based on a display setting of external device 200 and generate a signal based on the reconfigured image data in response to controller 180. The present invention, however, is not limited thereto. Such an operation may be performed by controller 160. The image data may be data for displaying a graphic user interface produced by any software programs installed in user equipment 100, such as an operating system and applications installed in user equipment 100.

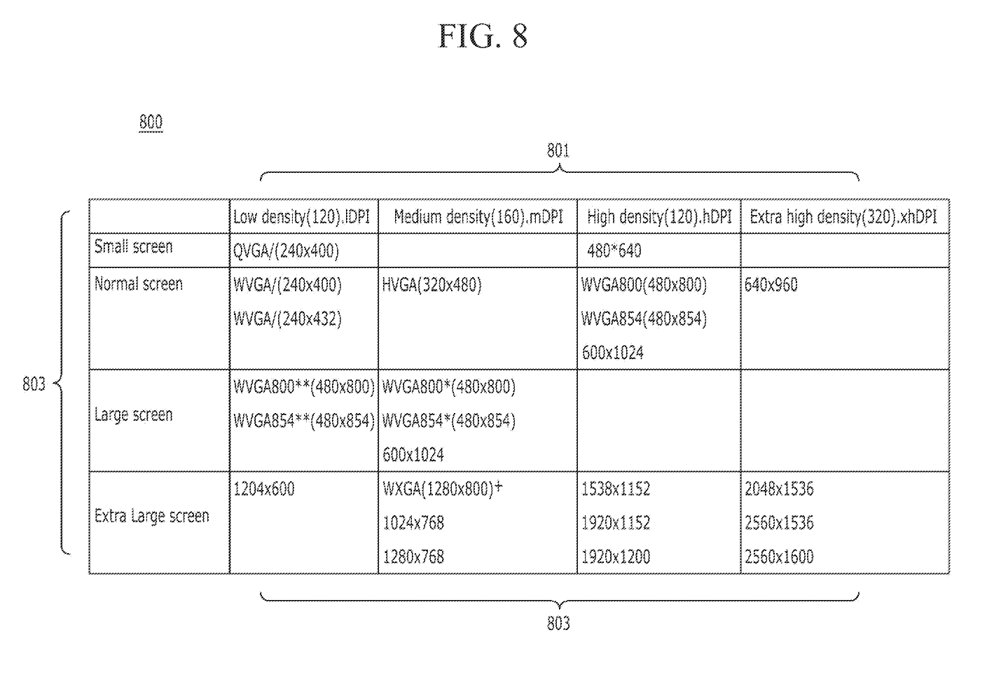

Internal memory 150 and external memory 155 may be used as a data storage device of user equipment 100. For example, internal memory 150 and external memory 155 may store information necessary for operating user equipment 100 and performing certain operations requested by a user. Such information may include any software programs and related data. For example, internal memory 150 and external memory 155 may store an operation system data, applications, and related data, received from an external device through a physical cable and downloaded from a related server from through a communication link. In accordance with an embodiment of the present invention, internal memory 150 and/or external memory 155 may store information on display setting determined for display unit 160 or display unit 210 of external device 200. Furthermore, internal memory 150 and external memory 155 may store device unit information for candidate external devices connectable to user equipment 100. In addition, internal memory 150 and/or external memory 150 may store a DPI table 800 shown in FIG. 8. Internal memory 150 may be a flash memory, hard disk, multimedia card micro memory, SD or XD memory, Random Access Memory (RAM), Static Random Access Memory (SRAM), Read-Only Memory (ROM), Programmable Read-Only Memory (PROM)_{;} Electrically Erasable Programmable Read-Only Memory (EEPROM), magnetic memory, magnetic disk, or optical disk, but is not limited thereto. External memory 155 may be a SD card or a USB memory, but the present invention is not limited thereto. For example, external device 200 may function as external memory 155 when external device 200 is coupled to user equipment 100 in accordance with an embodiment of the present invention.

Display unit 160 may be an output device for visually displaying information. For example, display unit 160 may display image data produced or processed by video processing unit 140 and/or controller 180. Display unit 160 may receive the image data from at least one of video processing unit 140 and controller 180 and display the received image data. The image data may be produced as a result of certain operations performed by any software programs installed in user equipment 100. For example, the image data may be data processed for displaying a graphic user interface produced by an operation system and applications, performed in user equipment 100. The applications may be referred to as App. Also, the image data may further include still images and moving images, produced or processed by video processing unit 140 and controller 180. For example, display unit 160 may be a liquid crystal display (LCD) panel or an active-matrix organic light-emitting diode (AMOLED) panel, but the present invention is not limited thereto.

In accordance with an embodiment of the present invention, display unit 160 may be interrupted to display the image data when user equipment 100 is connected to external device 200. For example, display unit 160 may be turned off or transit to a sleep mode in response to controller 180 when user equipment 100 is connected to external device 200. Display unit 160 may be turned on again or transit back to an operation mode in response to controller 180 when user equipment 100 is disconnected from external device 200.

Audio output unit 165 may provide an output audio signal that may be produced or processed by controller 180 as a result of operations performed by an operating system and/or applications installed in user equipment 100. Audio output unit 165 may include a speaker, a receiver, and a buzzer.

Port unit 170 may include at least one port for exchanging signals and/or data with external device 200. In accordance with an embodiment of the present invention, port unit 170 may transfer image data and audio data from user equipment 100 to external device 200. Port unit 170 may exchange control data with external device 200. Port unit 170 may be coupled to corresponding port unit 250 of external device 200 in various coupling manners. For example, port unit 170 may be coupled to corresponding port unit 250 of external device 200 through a physical cable. Furthermore, port unit 170 may be directly interlocked with corresponding port unit 250 of external device 200. The present invention, however, is not limited thereto. Port unit 170 may be coupled to corresponding port unit 250 of external device 200 through a radio link formed between user equipment 100 and external device 200. In this case, port unit 170 and port unit 250 may include a signal transmitter and receiver (not shown) for communicating with each other using a communication protocol. Such communication protocol may be Bluetooth, but the present invention is not limited thereto.

As shown in FIG, 4, port unit 170 may include video input/output port 172, audio input/output port 174, and data input/output port 176, but the present invention is not limited thereto. Such port unit 170 may be embodied in various types. For example, port unit 170 may not include audio input/output interface 174. Further, port unit 170 may include a power port (not shown). In this case, the power port may transfer power from external device 200 to user equipment 100 when external device 200 is coupled to user equipment 100.

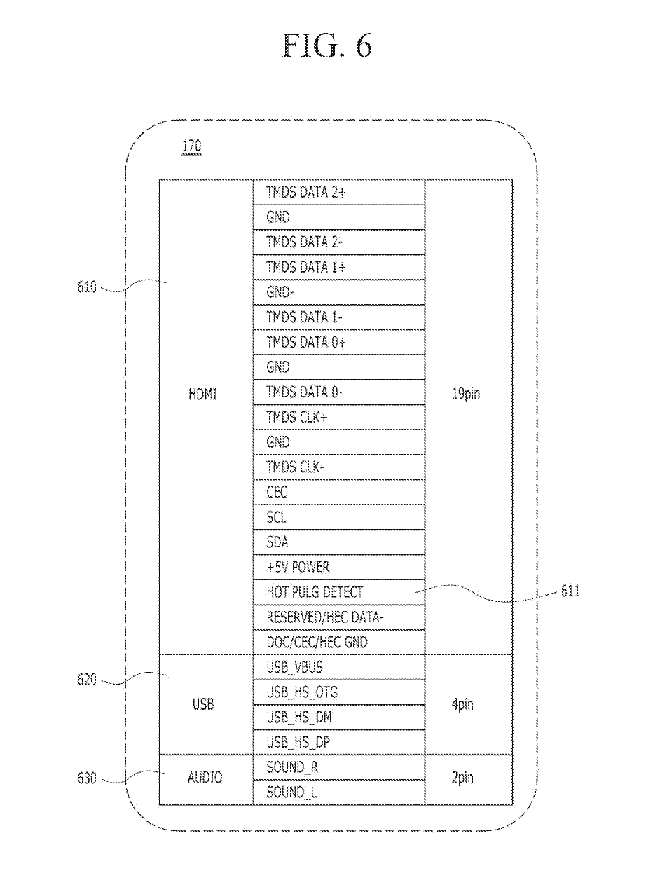

Port unit 170 will be described in detail with reference to FIG. 6 in later. Referring to FIG. 6, port unit 170 may be an interface for inputting and outputting audio and video signals and control signals. Port unit 170 may include high definition multimedia interface (HDMI) port 610, universal serial bus (USB) port 620, and audio port 630. For example, video input/output port 172 may be HDMI port 610, audio input/output port 174 may be audio port 630, and data input/output pot 176 may be USB port 620 (see FIG. 6). The present invention, however, is not limited thereto. In another embodiment of the present invention, port unit 170 may include other types of connectors and ports.

In accordance with an embodiment of the present invention, user equipment 100 may be coupled to external device 200 through port unit 170. After user equipment 100 coupled to external device 200, user equipment 100 may control external device 200 by exchanging data with external device 200 through port unit 170. For example, user equipment 100 may receive inputs from a user through external device 170 and transmit control data to external device 170 through port unit 170. Particularly, user equipment 100 may transmit image data through port unit 170 to external device 200 and control external device 200 to display the image data such a graphic user interface instead of display unit 160 of user equipment 100.

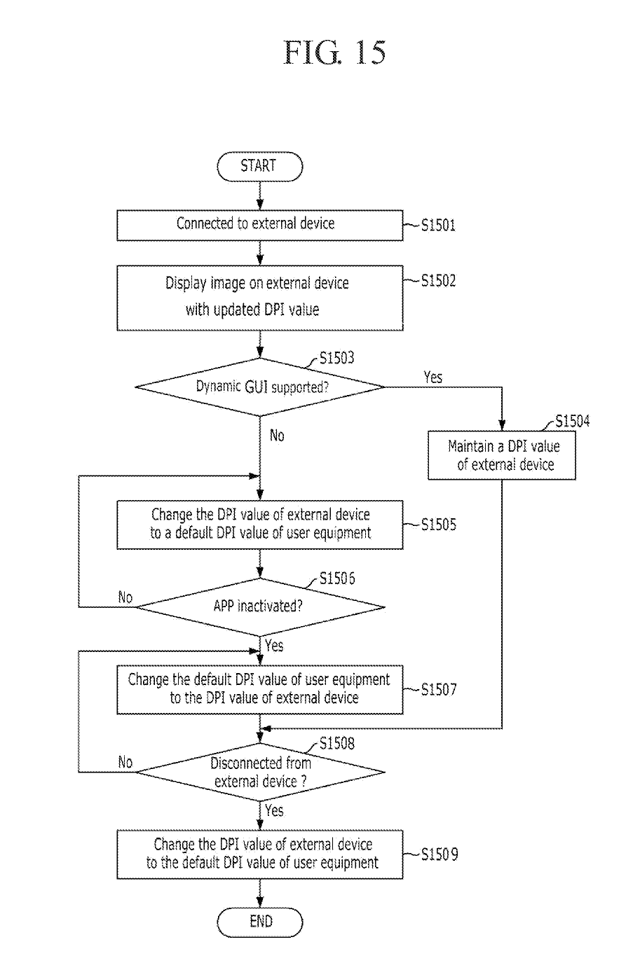

Returning to FIG. 4, controller 180 may control overall operation of the constituent elements of user equipment 100. Particularly, controller 180 may perform operations necessary for driving the constituent elements of user equipment 100 in response to inputs received from a related user. In accordance with an embodiment of the present invention, controller 180 may control overall operation of constituent elements of external device 200 when user equipment 100 is connected to external device 200. For example, controller 180 may receive inputs through external device 200, perform an operation in response to the received inputs, and provide the user with the result thereof through external device 200. Particularly, controller 180 may display image data, as a result of operation related to the user inputs, on a display unit of external device 200 when user equipment 100 is connected to external device 200. In order to display the image data on external device 200, controller 180 may include agent 182. Agent 182 may control operations related to connection to external device 200 and controlling external device 200. Such agent 182 may be referred to as a coupling agent or a docking agent, but the present invention is not limited thereto. Agent 182 may be implemented in software. For example, agent 182 may be realized on an application layer in an operating system (OS) structure of user equipment 100. For example, such an OS structure may be an OS structure of an android operating system, but present invention is not limited thereto. Detailed operations of agent 182 will be described in detail with reference to FIG. 9 to FIG. 15. Furthermore, controller 180 may include application framework 184. Application framework 184 may be an application framework layer of the OS structure and implemented in software. In accordance with an embodiment of the present invention, application framework 184 may perform operations for controlling a display setting in response to associated applications producing image data when user equipment 100 is connected to external device 200. Application framework 184 may cooperate with agent 182 for controlling the display setting for user equipment 100 and external device 200. Detailed operations of application framework 184 will be also described with reference to FIG. 9 and FIG. 15.

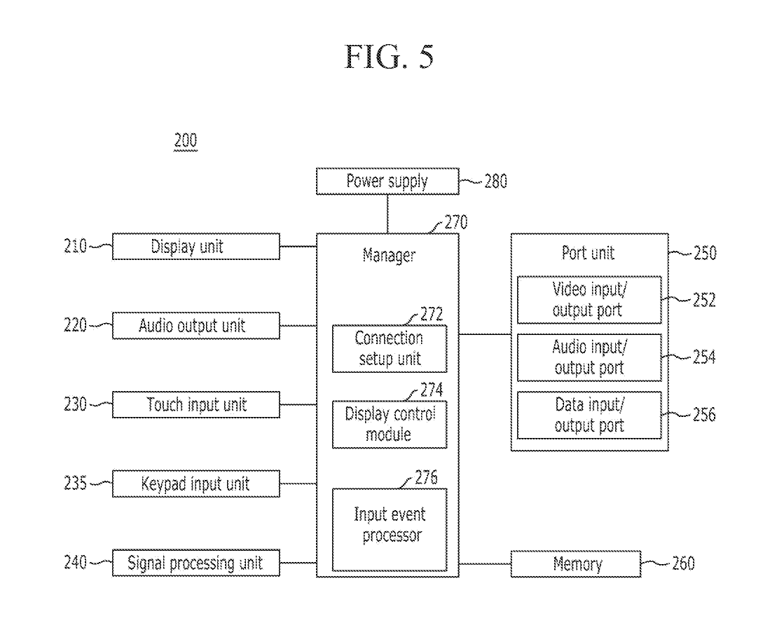

As described above, user equipment 100 may be connected to external device 200 and control external device 200. External device 200 may perform operation under the control of user equipment 100 after connected to user equipment 100. For example, external device 200 may be a dummy terminal before connected to user equipment 100. When user equipment 100 is connected to external device 200, external device 200 may be activated and perform operations based on control data received from user equipment 100. Hereinafter, external device 200 will be described with reference to FIG. 5.

FIG. 5 shows an external device in accordance with an embodiment of the present invention.

Referring to FIG. 5, external device 200 may include display unit 210, audio output unit 220, touch input unit 230, keypad input unit 235, signal processing unit 240, port unit 250, memory unit 260, manager 270, and power supply 280. Display unit 210, audio output unit 220, touch input unit 230, keypad input unit 235, memory unit 260, and power supply unit 280 may be analogous to, and perform similar functions to, display unit 160, audio output unit 165, input unit 130, internal memory unit 150, and power supply unit 190 of user equipment 100. Accordingly, the detailed description thereof will be omitted herein. For convenience and ease of understanding, only constituent elements performing distinct operations are described herein.

Port unit 250 may be connected to port unit 170 of user equipment 100. That is, port unit 250 may be a connecting port for forming connectivity between user equipment 100 and external device 200. Accordingly, port unit 250 may be a pair relation with port unit 170 of user equipment 100. Port unit 250 may have the same interface configuration of that of port unit 170 of user equipment 100. For example, port unit 250 may have a HDMI port, a USB port, and an audio port.

Port unit 250 may include video input/output port 252, audio input/output port 254, and data input/output port 256. Video input/output port 252 may receive image data from user equipment 100. Audio input/output port 254 may receive audio signals. Data input/output port 256 may exchange data with user equipment 100. Furthermore, port unit 250 may include a power port (not shown) for transferring power to user equipment 100 and a sensing port (not shown) for sensing connection formed between user equipment 100 and external device 200. The present invention, however, is not limited thereto. For example, port unit 250 may be connected to user equipment 100 through a radio link formed between user equipment 100 and external device 200. In this case, port unit 250 may include a signal transmitter and receiver (not shown) for communicating with each other using a communication protocol. Such communication protocol may be Bluetooth, but the present invention is not limited thereto.

Referring back to FIG. 2, external device 200 may include coupling bay 251 in accordance with an embodiment of the present invention. Port unit 250 may be disposed on one side of coupling bay 251. Coupling bay 251 may be formed at a part of a rear side of external device 200. Coupling bay 215 may have a space for housing user equipment 100. User equipment 100 may be inserted into coupling bay 215. In accordance with an embodiment of the present invention, port unit 170 of user equipment 100 may be connected with port unit 250 of user equipment 200 when user equipment 100 is completely inserted into coupling bay 251.

Manager 270 may control overall operation for controlling constituent elements of external device 200 in response to user equipment 100 when external device 200 is coupled to user equipment 100. In accordance with an embodiment of the present invention, manager 270 may receive control data from user equipment 100 through port unit 250 and perform operation response to the control data. Furthermore, manager 270 may receive inputs from a related user and transmit the received input to user equipment 100 through port unit 250. Manager 270 may include connection setup unit 272, display control module 274, and input event processor 276 in accordance with an embodiment of the present invention.

Connection setup unit 272 may activate the constituent elements of external device 200 when external device 200 initially senses that external device 200 is connected to user equipment 100. For example, connection setup unit 272 may supply power to the constituent elements of external device 200. That is, connection setup unit 272 may transit a waiting state of external device 200 to a wakeup state of external device 200. Accordingly, connection setup unit 272 may establish a host-device connection between user equipment 100 and external device 200.

External device 200 may provide a graphic user interface about identical to displayed on user equipment 100 when external device 200 is connected to user equipment 100. In such a connected state, image data displayed on display unit 160 of user equipment 100 may be transferred to and displayed on display unit 210 of external device 200. In order to display the transferred image data on display unit 210, manager 270 may include display control module 274. Display control module 274 may turn on display unit 210 under control of manager 270 when external device 200 is connected to user equipment 100. Then, manager 274 may receive the image data displayed on display unit 160 of user equipment 100 from user equipment 100 and display the received image data on display unit 210 of external device 200.

When touch input unit 230 and keypad input unit 235 of external device 200 receive input events such as a touch input in a connected state, input event processing unit 276 may generate an event signal corresponding to the input events and transfer the generated event signal to user equipment 100. The generate event signal may be a signal for controlling operation of user equipment 100 corresponding to the received input events.

In accordance with an embodiment of the present invention, external device 200 may not operate in a disconnected state. The disconnected state may denote a state that user equipment 100 is not connected to external device 200. Accordingly, external device 200 may be a dummy device. In this case, external device 200 may include minimum elements for performing essential functions such as display control and touch input control.

As described above, external device 200 may be connected to user equipment 100 and perform operations under the control of user equipment 100 in accordance with an embodiment of the present invention. Such operation may be performed by exchanging data through port units 170 and 250. Such port units 170 and 250 may be illustrated in FIG. 6. For convenience and ease of understanding, port unit 170 is representatively shown in FIG. 6.

FIG. 6 shows a port unit of user equipment in accordance with an embodiment of the present invention.

Referring to FIG. 6, port unit 170 of user equipment 100 may include HDMI port 610, USB port 620, and audio port 630. HDMI port 610 may include 19 pins for exchanging signals designated to each pin. For example, HDMI port 610 may include hot plug detect (HPD) pin 611. HPD pin 611 may generate a detection signal when user equipment 100 is connected to external device 200. Based on the detection signal generated by HPD pin 611, user equipment 100 may determine that user equipment 100 is connected to external device 200. HDMI port 610 may mainly exchange image data with external device 200. USB port 620 may include 4 pins for mainly exchanging data with external device 200. Furthermore, audio port 630 may include 2 pins for exchanging audio data with external device 200. Although FIG. 6 shows port unit 170 having HDMI port 610, USB port 620, and audio port 630 to connect user equipment 100 with external device 200, the present invention is not limited thereto.

In accordance with an embodiment of the present invention, user equipment 100 is coupled with external device 200 shown in FIG. 5 though port unit 1170 provided therein. The present invention, however, is not limited thereto. For example, user equipment 100 may be coupled to other electronic devices or appliances such as TV and computer monitors having such HDMI port and/or USB port to output audio/video signals thereto.

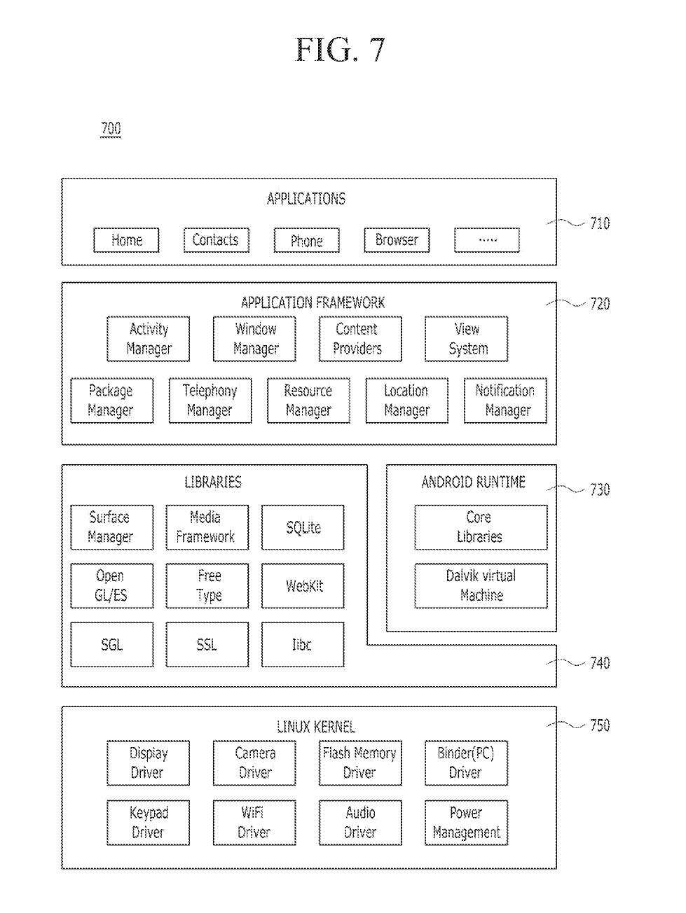

FIG. 7 shows an operating system architecture in accordance with an embodiment of the present invention.

Referring to FIG. 7, operating system (OS) architecture 700 may have a multi-layered structure. For example, FIG. 7 shows android OS architecture 700. Such android OS stricture 700 may include application layer 710, application framework layer 720, android runtime layer 730, library layer 740, and Linux kernel layer 750. Linux kernel layer 750 may consist of an Android kernel based on Linux and is the layer closest to the hardware. Above Linux kernel layer 750 may reside android runtime layer 730 and library layer 740, which may contain the run-time libraries and the Dalvik Virtual Machine (DVM). The run-time libraries may consist of open-source technologies such as the Webkit browser, SQLite database, and FreeType text rendering. They may handle the low-level data, network., and graphic requests made by Android applications. Application framework layer 720 may implement a toolkit of higher-level application services such as window management, process notifications, and inter-application communications.

In accordance with an embodiment of the present invention, agent 182 of user equipment 100 may be implemented in software included in application layer 710. Agent 182 may control connection to external device 200 and adjust display settings according to connectivity of external device 200 in cooperation with application framework 184 included in application framework layer 720.

As described above, a display setting may be controlled based on display unit information when user equipment 100 is connected to external device 200. User equipment 100 may refer to information stored in internal memory 150 to control the display setting. For example, user equipment 100 may refer to a dots per inch (DPI) table for controlling the display setting. FIG. 8 shows a dots per inch (DPI) table in accordance with an embodiment of the present invention.

Referring to FIG. 8, DPI table 800 may include a plurality of DPI values 801 designated according to screen sizes 802 and screen resolutions 803. DPI table 800 may include DPI values required for the android OS. When a DPI value is desirably adjusted, user equipment 100 may refer to DPI table 800 to select an appropriate DPI value corresponding to display unit information of external device 200. For example, assuming that display unit 160 of user equipment 100 has a screen resolution of 640×960 and a normal screen size of about 4 inches, an appropriate DPI value for user equipment 100 may be determined as extra high density (320).xhDPI in DPI table 800. On the other hand, assuming that display unit 210 of external device 200 has a screen resolution of 800×1280 and an extra-large screen size of about 10 inches, an appropriate DPI value for external device 200 may be determined as medium DPI (160).mDPI in DPI table 800.

When user equipment 100 is connected to external device 200, user equipment 100 may display image data on display unit 210 of external device 200, instead of display unit 160 of user equipment 100. In order to properly display the image data on display unit 210 of external device 200, user equipment 100 may control a display setting to be properly to display unit 210. The display setting may include at least one of a screen size, a screen resolution, a DPI value, a display layout, and a display direction. Hereinafter, overall operation for controlling a display setting according to external device 200 when user equipment 100 is connected to external device 200 will be described with reference to FIG. 9 to FIG. 15.

FIG. 9 shows a method for controlling display setting information according to an external device connected to user equipment in accordance with an embodiment of the present invention.

Referring to FIG. 9, image data may be displayed on display unit 160 of user equipment 100 at step S910. For example, user equipment 100 may display the image data according to a default display setting of user equipment 100. The default display setting may be information on properties initially set up for displaying the image data on a corresponding display unit. In accordance with an embodiment of the present invention, the default display setting may be an initial display setting for user equipment 100. In general, display setting properties may include a dot per inch (DPI) value, a screen resolution, and a screen size. The default display setting of user equipment 100 may be controlled based on display unit information of display unit 160 of user equipment 100. The display unit information may be information on a corresponding display unit. For example, the display unit information may be hardware specification information of a corresponding display unit. Accordingly, the display unit information may include information on a manufacturer, a model number, a device identifier (ID), an appropriate DPI value, a screen size, the number of pixels, supporting screen resolutions, luminance, supporting aspect ratios, refresh rates, and a response time.

At step S920, determination may be made as to whether external device 200 is connected to user equipment 100. For example, user equipment 100 may detect connection to external device 200 based on a detection signal generated at port unit 1170 of user equipment 100. As shown in FIG. 6, port unit 170 may include HDMI port 610. In this case, hot plug detect (HPD) pin 611 of HDMI port 610 may generate a HPD signal when HDMI port 610 of user equipment 100 is coupled to port unit 250 of external device 200. The generated HPD signal may be transferred to agent 182 of user equipment 100. Upon the receipt of the HPD signal, agent 182 may determine that external device 200 is connected to user equipment 100. The present invention, however, is not limited thereto User equipment 100 may detect connection to external device based on communication with external device 200. As shown in FIG. 6, port unit 170 may include USB port 620. In this case, user equipment 100 may communicate with external device 200 through USB port 620 when user equipment 100 is connected to external device 200. Particularly, user equipment 100 may communicate with external device 200 through a USB net and/or an android debug bridge (ADB),

When external device 200 is not connected to user equipment 100 (No—S920), display unit 160 of user equipment 100 may continuously display the image data based on the default display setting at step S910.

After detecting the connection to external device 200, user equipment 100 may start displaying the image data on display unit 210 of external device 200 and interrupt displaying the image data on display unit 160 of user equipment 100. For example, agent 182 may turn off display unit 160 of user equipment 100 or control display unit 160 to transit to a sleep mode. Then, agent 182 may change a data path of image data from user equipment 100 to external device 200. That is, agent 182 may interrupt displaying the image data on display unit 160 of user equipment 100 and start displaying the image data on display unit 210 of external device 200 as follows.

When external device 200 is connected to user equipment 100 (Yes—S920), display unit information of external device 200 may be obtained at step S930. For example, user equipment 100 may request display unit information to external device 200 and Obtain the display unit information from external device 200. Alternatively, user equipment 100 may identify a display unit type of external device 200 and retrieve related display unit information from internal memory 150. Particularly, agent 182 may request and receive display unit information from external device 200. Based on the display unit information, agent 182 may identify hardware specification of display unit 210 of external device 200. For example, agent 182 may receive extended display identification data (EDID) from external device 200. The EDID may be information on hardware specification of display unit 210 of external device 200. The EDID may include information on a manufacturer, a model number, an EDID version, an appropriate DPI value, a screen size, supporting screen resolutions, luminance, and the number of pixels. The present invention, however, is not limited thereto. For example, user equipment 100 may store, in internal memory 150, display unit information of candidate external devices that might be connected to user equipment 100. The stored display unit information may be mapped to a device ID of each candidate external device. Such mapping information may be managed by agent 182 of user equipment 100. In this case, user equipment 100 may receive or recognize a device ID of external device 200. Based on the device ID, user equipment 100 may obtain the display unit information of display unit 210 of external device 200 from the stored display unit information.

At step S940, image data may be reconfigured based on the obtained display unit information of external device 200. For example, user equipment 100 may reconfigure the image data based on the obtained display unit information. That is, user equipment 100 may reconfigure the image data to be properly displayed on display unit 210 of external device 200. For example, the image data may be redrawn according to a screen layout changed according to a DPI value, a screen resolution, and a screen size included in the obtained display unit information.

At step S950, the reconfigured image data may be transmitted to external device 200 with the external device display setting. For example, user equipment 100 may transmit the reconfigured image data to external device 200 with the external device display setting.

At step S960, the image data may be displayed on display unit 210 of external device 200 based on the external device display setting. For example, external device 200 may receive the reconfigured image data and display the received image data on display unit 210 in response to the control of user equipment 100.

At step S970, nation may be made whether user equipment 100 is disconnected from external device 200. For example, user equipment 100 may detect decoupling or de-docking from external device 200. As described above, such detection of disconnection from external device may be determined based on a device release signal made by port unit 170, but the present invention is not limited thereto.

When user equipment 100 is not disconnected from external device 200 (No—S970), the image data may be continuously displayed on display unit 210 based on the external device display setting, which is tailored according to the display unit information of external device 200. On the contrary, when user equipment 100 is disconnected from external device 200 (Yes—S970), the external device display setting may be changed to the default display setting at step S980. For example, user equipment 100 may restore the default display setting.

The image data may be displayed on display unit 160 of user equipment 100 based on the default display setting at step S990. For example, after restoring the default display setting, user equipment 100 may display the image data on display unit 160 based on the default display setting.

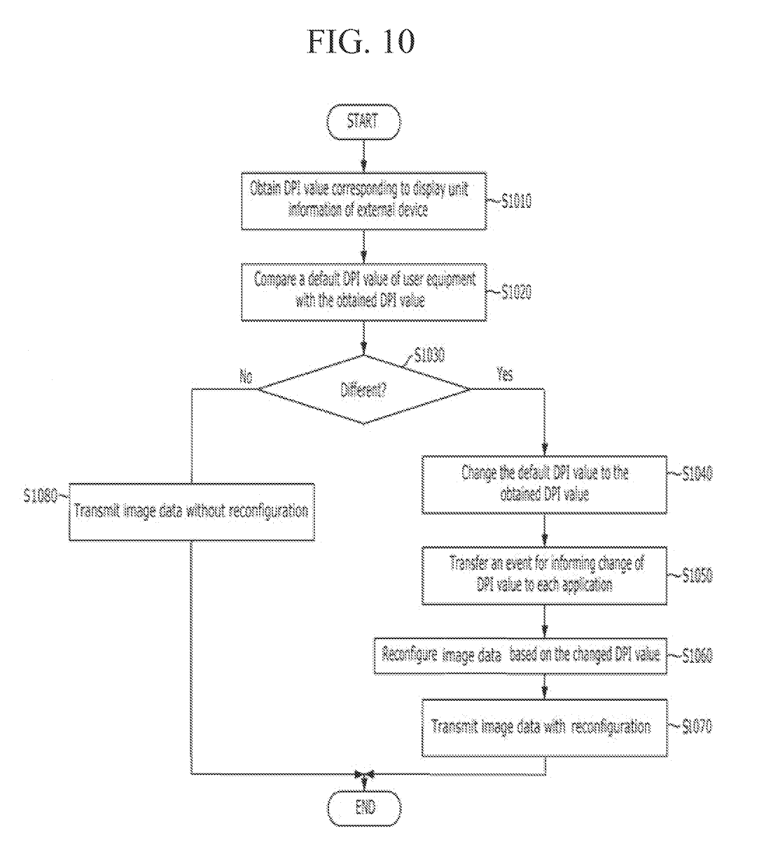

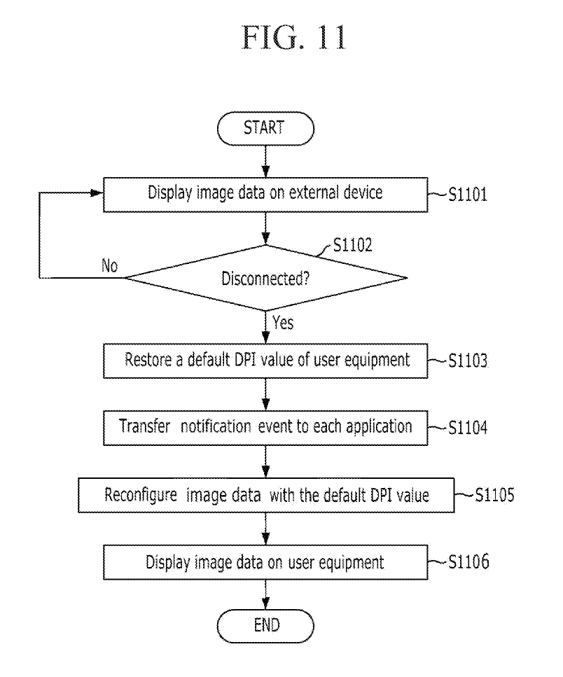

As described above, when user equipment 100 is connected to external device 200, user equipment 100 may change the default display setting to the external device display setting in order to appropriately display the image data on display unit 210 of external device 200. Such display setting may be controlled by adjusting display setting properties including a DPI value, a screen resolution, a display direction and a screen size for display unit 210 of external device 200. For convenience and ease of understanding, among the display setting properties, controlling the DPI value may be representatively described in more detail, hereinafter. Although the DIP value is controlled in accordance with an embodiment of the present invention, the present invention is not limited thereto. Other display setting properties may be controlled in similar manners and/or simultaneously with the DPI value as shown in FIG. 10 through FIG. 11. In an embodiment of the present invention, user equipment 100 may change a default DPI value determined for user equipment 100 to a DPI value determined for external device 200. Hereinafter, a method for controlling a DPI value according to an external device connected to user equipment in accordance with an embodiment of the present invention will be described with reference to FIG. 10.

FIG. 10 shows a method for controlling a DPI value according to an external device when user equipment is connected to the external device in accordance with an embodiment of the present invention.

Referring to FIG. 10, a DPI value may be obtained from display unit information of external device 200 at step S1010. As described above, the display unit information of external device 200 may be obtained from external device 200 or retrieved from internal memory 150 based on a device ID of external device 200. Agent 182 of user equipment 100 may obtain a DPI value for external device 200, based on the obtained display unit information of external device 200. The DPI value may be obtained from DPI table 800 shown in FIG. 8. DPI table 800 may include a plurality of DPI values 801 designated according to screen sizes 802 and screen resolutions 803. Agent 182 may refer to DPI table 800 to obtain an appropriate DPI value for display unit 210 of external device 200 based on the display unit information of display unit 210.

For convenience and ease of understanding, it is assumed that display unit 160 of user equipment 100 may have a screen resolution of 800×1280 and a normal screen size of about 4 inches and that display unit 210 of external device 200 may have a screen resolution of 800×1280 and an extra-large screen size of about 10 inches. In this case, an appropriate DPI value for user equipment 100 may be an extra-high DPI (XHDPI) value, and an appropriate DPI value for external device 200 may be a medium DPI (MDPI) value according to DPI table 800. In accordance with an embodiment of the present invention, image data may be displayed on display unit 160 of user equipment 100 with the XHDPI value before user equipment 100 is connected to external device 200. After user equipment 100 is connected to external device 200, the image data may be displayed on display unit 210 of external device 200. In order to appropriately display the image data on display unit 210 of external device 200, the image data should be displayed with the MDPI value, which is an appropriate DPI value for external device 200. Accordingly, agent 182 of user equipment 180 may select an appropriate DPI value for external device 200 from DPI table 800, reconfigure the image data with the selected DPI value, and transmit the reconfigured image data to external device 200.

An embodiment of the present invention is described as selecting the appropriate DPI value from DPI table 800. The present invention, however, is not limited thereto. For example, an appropriate DPI value may be retrieved from internal memory 150 based on a device ID of external device 200. As described above, the device ID of external device 200 may be recognized or received from external device 200. In this case, a DPI value mapped to the device ID of external device 200 may be obtained from internal memory 150 of user equipment 100. Such information may be included in display unit information of candidate external devices, which is stored in internal memory 150 of user equipment.

At step S1020, the obtained DPI value may be compared with a default DPI value of user equipment 100. For example, agent 182 may determine whether to change the default DPI based on the obtained DPI value by comparing the obtained DPI value with the default DPI value. At step S1030, a comparison determines whether the obtained and default DPI values are different.

When the obtained DPI value is not different from the default DPI value (No—S1030), image data may be transmitted to external device 200 without reconfiguration at step S1080. For example, when agent 182 determines not to change the default DPI, agent 182 may transmit current image data to external device 200 without reconfiguration.

When the obtained DPI value is different from the default DPI value at step (Yes—S1030), user equipment 100 may perform following operation in order to appropriately display the image data on display unit 210 of external device 200.

At step S1040, the default DPI value may be changed to the obtained DPI value. For example, agent 180 may request application framework 184 to change the default DPI value. Accordingly, application framework 184 may update the default DPI value included in system configuration information of user equipment 100 with the obtained DPI value. The system configuration information may include display setting information of user equipment 100.

At step S1050, application framework 184 may transfer a system configuration change notification event to applications that may be in operation or that may be requested to be operated. The system configuration change notification event may be an event invoked for notifying of the applications that the default DPI value is changed to the obtained DPI value. The system configuration change notification event may be a “android.Internet.Action.CONFIGURATION_CHANGE” event. Furthermore, application framework 184 may control applications, which are in operation or requested to be operated, to reconfigure a screen layout o be displayed with the updated DPI value.

At step S1060, the applications in operation or the application requested to be operated may reconfigure the image data by adjusting a screen layout based on the updated DPI value. The image data may be reconfigured by following three methods in accordance with an embodiment of the present invention.

As a first method, application framework 184 may forcedly and directly drive graphic user interface components and activities of each application again. In this case, graphic user interfaces of the applications may be reconfigured with the updated DPI value.

As a second method, application framework 184 may call a system configuration change function. For example, the system configuration change function may be “onConfigurationChanged( )” for an android operation system. In this case, the applications may redraw a graphic user interface with the updated DPI value. However, such operation of application framework 184 may differ according to an operation system of user equipment 100.

As a third method, application framework 184 may obtain a list of the applications currently in operation and terminate the applications in the obtained list through a process kill operation. When corresponding applications are initiated again by a user or a system, the applications may reconfigure a corresponding graphic user interface with the updated DPI value.

The terminated applications may be all of applications currently in operation, except certain applications. For example, the certain applications may be an application required to be continually performed for maintaining service continuity. The certain application may be essential programs for controlling connection to external device 200 and for adjusting display setting information. The certain application may include, for example, a call application, a music application, and an agent program. The present invention, however, is not limited thereto. Such certain applications may be differently designated by a user or a system designer.

The process kill operation may differ according to a type of an operation system of user equipment 100. For example, before performing the process kill operation, application framework 184 may initiate a certain test application, to be operated on a forward ground, for very short time such as about server seconds. In this case, previous applications in operation on a forward ground may transit to a background mode. Such operation may cause the previous applications in operation to store current statuses thereof. Accordingly, the previous running applications may not loose related data although the previous running applications are terminated by the process kill operation.

As described above, the image data may be configured or reconfigured by adjusting a screen layout based on the updated DPI value at step S1060. Then, agent 184 may transmit the reconfigured image data with the adjusted screen layout to external device 200 through port unit 170 at step S1070.

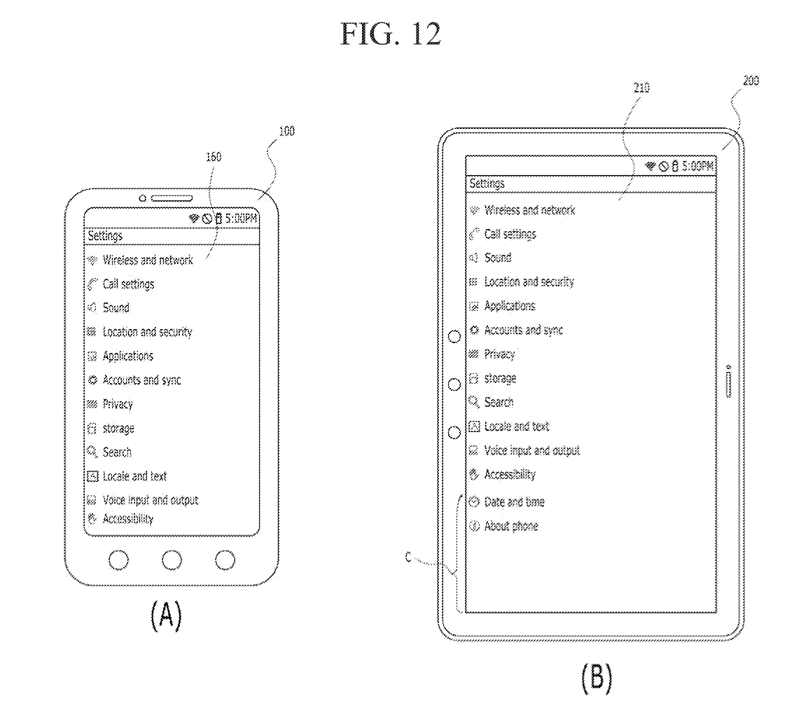

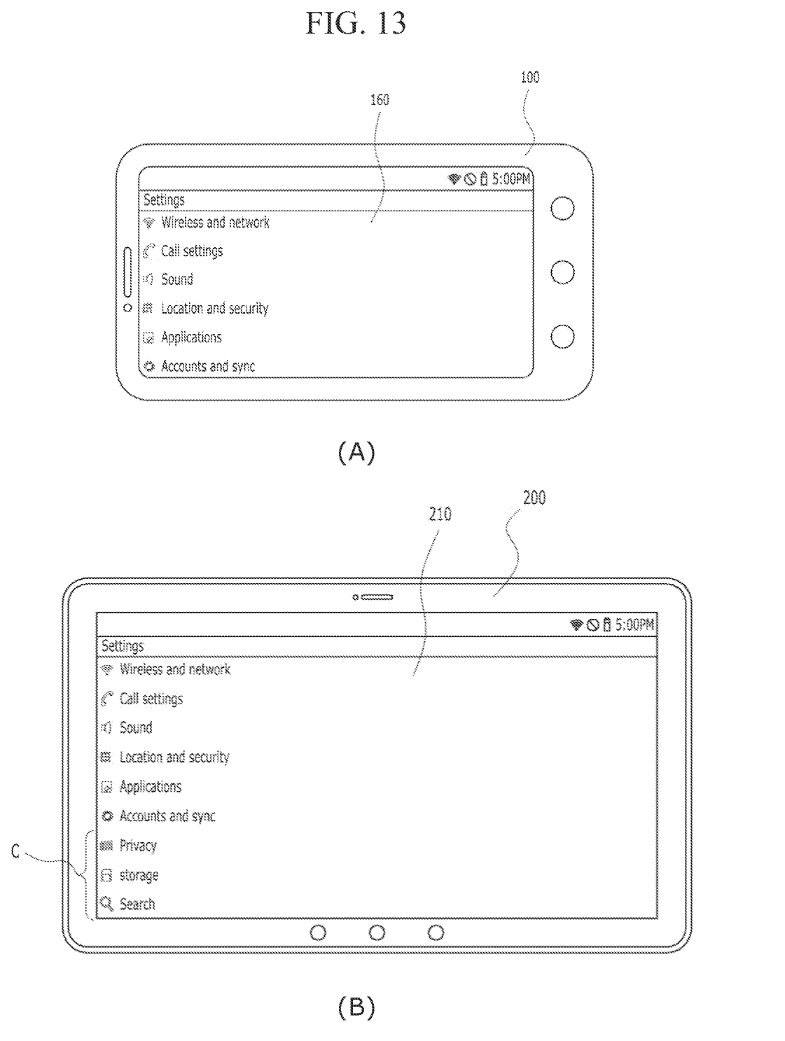

As described above, when user equipment 100 is connected to external device 200, the image data may be reconfigured with a DPI value obtained for display unit 210 of external device 200. Accordingly, the image data may be appropriately displayed on display unit 210 of external device 200. Such reconfigured image data with the adjusted screen layout may be shown in FIG. 12 and FIG. 13, described subsequently below. When external device 200 is disconnected from user equipment 100, user equipment 100 may interrupt displaying the image data on display unit 210 of external device 200 and start displaying the image data on display unit 160 of user equipment 100. Accordingly, user equipment 100 may be required to control a display setting for display unit 160 of user equipment 100. For example, user equipment 100 may restore the default display setting. Hereinafter, a method for controlling a DPI value according to an external device connected to user equipment when the user equipment is disconnected from the external device in accordance with an embodiment of the present invention.

FIG. 11 shows a method for controlling a DPI value according to an external device connected to user equipment when the user equipment is disconnected from the external device in accordance with an embodiment of the present invention.

Referring to FIG. 11, image data may be displayed on display unit 210 of external device 200 at step S1101. For example, user equipment 100 may display the image data on display unit 210 of external device 200 with a DPI value determined for external device 200 after user equipment 100 is connected to external device 200. Particularly, user equipment 100 may display a graphic user interface with a screen layout based on the DPI value determined for external device 200. For convenience and ease of understanding, the DPI value determined for external device 200 may be referred to as an updated DPI value, hereinafter.

At step S1102, determination may be made as to whether user equipment 100 is disconnected from external device 200. For example, such determination may be made by agent 182. Agent 182 may detect the disconnection from external device 200 when agent 182 receives a disconnection signal that may be generated by port 170. When agent 182 does not receive the disconnection signal (No—S1102), the image data may be continuously displayed on display unit 210 of external device 200 with the update DPI value at step S1101.

When agent 182 receives the disconnection signal (Yes—S1102), agent 182 may perform necessary operation for interrupting displaying the image data on external device 200 and for starting displaying image data on display unit 160 of user equipment 100, as follows. For example, again 182 may restore a default display setting and control an image data path from display unit 210 of external device 200 to display unit 160 of user equipment 100. The default display setting may be a display setting configured for user equipment 100. The default display setting may include a default DPI value which is initially determined for display unit 160 of user equipment 100.

At step S1103, a default DPI value for user equipment 100 may be restored when external device 200 is disconnected from user equipment 100. For example, agent 182 may request application framework 184 to restore the default DPI value for user equipment 100. In response to the request, application framework 184 may change the updated DPI value to the default DPI value and modify system configuration information with the default DPI value. That is, the updated DPI value may be a DPI value updated for display device 210 of external device 200. The default DPI value may be a DPI value originally set up for display device 160 of user equipment 100.

At step S1104, a system configuration change notification event may be transmitted to applications. For example, application framework 184 may transmit a system configuration change notification event to applications in operation or requested to be operated after restoring the default DPI value. The system configuration change notification event may notify of the applications that the updated DPI value is changed to the default DPI value.

At step S1105, image data may be reconfigured with the default DPI value. For example, the applications may reconfigure the image data by adjusting a screen layout with the default DPI value.

At step S1106, he reconfigured image data may be displayed on display unit 160 of user equipment 100. For example, controller 1180 of user equipment 100 may display the image data with the reconfigured screen layout on display unit 160 of user equipment 100.

As described above, the method in accordance with an embodiment of the present invention was described as controlling a DPI value when user equipment 100 is connected to and/or disconnected from external device 200. However, the present invention is not limited thereto. Beside the DPI value, a screen size and/or a screen display direction may be controlled, as display setting information, in accordance with an embodiment of the present invention.

As described above, when user equipment 100 is connected to external device 200, the image data may be reconfigured with a. DPI value determined for display unit 210 of external device 200 and displayed on display unit 210 of external device 200. Furthermore, when user equipment 100 is disconnected from external device 200, the image data may be reconfigured again with a DPI value determined for display unit 160 of user equipment 100. Particularly, user equipment 100 may display a graphic user interface, generated based on image data, on display unit 210 of external device 200 with a screen layout controlled for external device 200 based on the update DPI value when user equipment 100 is connected to external device 200. Furthermore, user equipment 100 may display a graphic user interface on display unit 160 of user equipment 100 with a screen layout controlled for user equipment 100 based on the default DPI value when user equipment 100 is disconnected from external device 200. Accordingly, the image data may be appropriately displayed on both of display unit 160 of user equipment 100 and display unit 210 of external device 200. The graphic user interface displayed with the reconfigured screen layouts may be shown in FIG. 12 and FIG. 13.

FIG. 12 and FIG, 13 show graphic user interfaces displayed on user equipment and an external device in accordance with an embodiment of the present invention.

Referring to FIG. 12 and FIG. 13, diagrams (A) of FIG. 12 and FIG. 13 show graphic user interfaces displayed on display unit 160 of user equipment 100 before user equipment 100 is connected to external device 200. Such graphic user interfaces may be displayed on display units 160 and 210 based on image data generated by user equipment 100. Particularly, the image data may be generated by software programs running on user equipment 100. For example, software programs may include applications, referred to as APPs.

Diagrams (B) of FIG. 12 and FIG. 13 show graphic user interfaces displayed on display unit 210 of external device 200 after user equipment 100 is connected to external device 200. As described above, display unit 160 of user equipment 100 may have a normal screen size and a screen resolution of 800×1280 and display unit 210 of external device 200 may have a large screen size and a screen resolution of 800×1280. That is, display unit 160 of user equipment 100 may display the graphic user interface with a default DPI value, for example, an XHDPI value, select according to DPI table 800 of FIG. 8. Display unit 210 of external device 200 may display the graphic user interface with an updated DPI value, for example, a MDPI value selected according to DPI table 800 of FIG. 8. Thus, user equipment 100 may reconfigure the image data with the updated DPI value and display the reconfigured image data on display unit 210 of external device 200.

As shown in diagrams (A) and (B) of FIG. 12 and FIG. 13, display unit 210 of external device 200 may further display a portion C which was not displayed on display unit 160 of user equipment 100. That is, user equipment 100 does not simply scale up image data in order to display the image data on display unit 210 of external device 200. Accordingly, more icons and menus may be displayed on display unit 210 of external device as compared with those displayed on display unit 160 of user equipment 100.

FIG. 12 and FIG. 13 show that display units 160 and 210 display the graphic user interface in the same display direction, one of a portrait direction and a landscape direction. The present invention, however, is not limited thereto. For example, display units 160 and 210 may display the graphic user interfaces in different display directions in accordance with another embodiment of the present invention. For example, display unit 160 of user equipment 100 may display a graphic user interface in the portrait direction as a default display direction and display unit 210 of external device 200 may display the same graphic user interface in the landscape direction as a default display direction.

In this case, agent 182 may obtain information on the default display directions of external device 200 from display unit information of external device 200. In this case, the display unit information may include a screen resolution, a screen size, and the default display direction. When the default display direction of external device 200 is not matched with that of user equipment 100, agent 182 may request application framework 184 to change a display direction of a graphic user interface for each related application based on the obtained default display direction of external device 200. That is, application framework 184 may control each application to reconfigure a screen layout based on the obtained default display direction as well as the updated DPI value. Accordingly, display unit 210 of external device 200 may display the image data with the screen layout reconfigured based on the obtained default display direction and the updated DPI value.

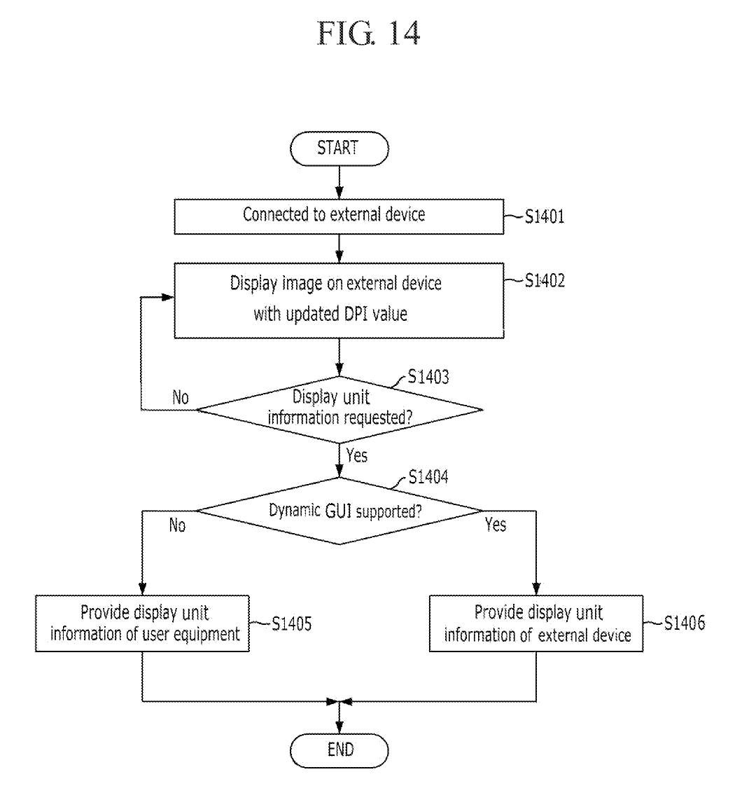

Hereinafter, a method for controlling a display setting according to an external device connected to user equipment in accordance with another embodiment of the present invention will be described with reference to FIG. 14 and FIG. 15. The methods of FIG. 14 and FIG. 15 may include an exception handling operation for an application or a related server that do not necessarily and dynamically provide a graphic user interface according to a display unit type of an external device connected to user equipment 100.

For example, an application, generally referred to as APP, may be downloaded from a related server in user equipment 100 and installed in user equipment 100. The installed application may perform a certain operation in response to inputs from a corresponding user after the user initiates the installed application. The application may generate image data based on the result of performing the certain operation and display the generated image data, such as a graphic user interface, on display unit 160 of user equipment 100. Such application may communicate with the related server to perform the certain operation. Lately, electronic devices such as user equipment 100 and external device 200 have been introduced with various types of display units. In order to properly display the operation result on according to a type of a display unit, the application and the related server may obtain display unit info nation of the corresponding device and generate image data, such as a graphic user interface, tailored according to the obtained display unit information. Some servers may provide an application tailored to the display unit type of user equipment when the user equipment accesses the server and attempt to download the application. For example, when a user attempts to download an application using a smart phone, a server may determine a display unit type of the smart phone and provide a smart phone type application, which is tailored according to the display unit type of the smart phone. When a user attempts to download the same application using a tablet PC, referred to as a pad type device, the server may determine a display unit type of the tablet PC and provide a pad type application, which is tailored according to the display unit type of the tablet PC. Such application may produce a graphic user interface tailored according to the corresponding display unit type.

In an embodiment of the present invention, user equipment 100 may be connected to external device 200 and display image data such as a graphic user interface on display unit 210 of external device 200 instead of display unit 160 of user equipment 100. Accordingly, a display unit might be changed while displaying a graphic user interface produced by the same application. In this case, an application producing a graphic user interface tailored according to a display unit type may cause interruption in displaying the graphic user interface. Accordingly, in another embodiment of the present invention, an exception handling operation may be performed to prevent such interruption when an application or a related server does not dynamically produce a graphic user interface according to a display unit type of a related device.

Such exception handling operation may be performed by i) providing fixed display unit information to an application or a related server in an exception list and/or by ii) changing display unit information back to initial display unit information. Hereinafter, such exception handling operation will be described with reference to FIG. 14 and FIG. 15.

FIG. 14 shows a method for controlling a display setting according to an external device connected to user equipment in accordance with another embodiment of the present invention. As described above, the method of FIG. 14 shows an exception handling operation in accordance with an embodiment of the present invention. Such an exception handling operation may be performed before and after user equipment 100 is connected to external device 200. For convenience and ease of understanding, the exception handling operation will be described as being performed after user equipment 100 is connected to external device 200. The present invention, however, is not limited thereto.

Referring to FIG. 14, user equipment 100 may be connected to external device 200 at step S1401. At step S1402, user equipment 100 may display image data on display unit 210 of external device 200 based on a DPI value updated according to external device 200. Since such operation was described with reference to FIG. 9 to FIG. 11, detailed description thereof is omitted herein.

At step S1403, determination may be made as to whether a request for display unit information is received. For example, an application may request display unit information in order to produce image data such as a graphic user interface properly to a display device type. User equipment 100 may determine whether such a request is received from an application or a different source, or if at all. Particularly; such an operation may be performed through application frame 184 when a related application protocol interface (API) is called. If no request is received (No—S1403), the method returns to step S1402.

When the request is received (Yes—S1403), determination may be made as to whether the application or a related server thereof supports a dynamic graphic user interface or not at step S1404. For example, user equipment 100 may determine whether the application requesting the display unit information or a related server thereof supports the dynamic graphic user interface or not. Particularly; such an operation may be performed through application framework 184.

When the application or a related server supports the dynamic graphic user interface (Yes—S1404), display unit information of external device 200 may be provided at step S1406. Since the application or the related server supports the dynamic graphic user interface, the application can produce image data proper to external device 200. Accordingly, user equipment 100 provides the display unit information of external device 200. Particularly, application framework 184 may provide the display unit information based on current system configuration information which is set up with the updated DPI value determined for external device 200.

When the application or the related server does not support the dynamic graphic user interface (No—S1404), display unit information of user equipment 100 may be provided at step S1405. Since the application of the related server does not support the dynamic graphic user interface, the application cannot produce image data proper to external device 200. Accordingly, user equipment 100 provides display unit information of user equipment 100. That is, user equipment 100 may provide initial display unit information although the initial display unit information is updated based on the external device 200. Particularly, application framework 184 may provide the initial display unit information of user equipment 100. Accordingly, the application or the related server may not recognize the default display unit information is changed. The application may transmit the provided display unit information to the related server.

As described above, the exception handling operation may provide the same display unit information regardless of whether user equipment 100 is connected to external device 200 in accordance with another embodiment of the present invention. Such an exception handling operation may prevent interruption that might be caused by the application or the related server does not support the dynamic graphic user interface.

FIG. 15 shows a method for controlling display setting information according to an external device connected to user equipment in accordance with another embodiment of the present invention. As described above, the method of FIG. 15 may include another exception handling operation in accordance with another embodiment of the present invention. Such an exception handling operation may be performed before and after user equipment 100 is connected to external device 200. For convenience and ease of understanding, the exception handling operation will be described as being performed after user equipment 100 is connected to external device 200. The present invention, however, is not limited thereto.

Referring to FIG. 15, user equipment 100 may be connected to external device 200 at step S1501. At step S1502, user equipment 100 may display image data on display unit 210 of external device 200 based on a DPI value updated according to external device 200. Since such operation was described with reference to FIG. 9 to FIG. 11, detailed description thereof is omitted herein.

At step S1503, determination may be made as to whether an activated application supports a dynamic graphic user interface or not. For example, an application may be activated when the application is initiated or when the application in a background mode transits to a foreground mode. When the application is initiated or when the application in a background mode transits to the foreground mode, user equipment 100 may determine whether the activated application supports a dynamic graph user interface or not. Such operation may be performed through application framework 182 with information stored in internal memory 150 or by communicating with a related server.

When the activated application supports the dynamic graphic user interface (Yes—S1503), a current DPI value may be maintained at step S1504. Since user equipment 100 is connected to external device 200, a DPI value of user equipment 100 may be updated in system configuration information with a DPI value determined for external device 200. Such the updated DPI value in the display unit information may be maintained because the application supporting the dynamic graphic user interface will produce a graphic user interface according to the updated DPI value. When the application requests display unit information, the display unit information having the updated DPI value may be prepared based on system configuration information and provided to the application. Such an operation may be performed through application framework 184. From step S1504, the method advances to step S1508 described subsequently.

When the activated application does not support the dynamic graphic user interface (No—S1503), a current DPI value may be changed back to a default DPI value of user equipment 100 at step S1505. Although the DPI value of user equipment 100 has been changed to the update DPI value determined for external device 200, the updated DPI value in system configuration information may be changed back to the DPI value of user equipment 100. By changing the updated. DPI value of external device 200 back to the initial DPI value of user equipment 100, display unit information prepared based on system configuration information may be not changed although user equipment 100 is connected to external device 200. That is, the application and a related application server may not recognize the display unit information is changed. Such an operation may be performed through application framework 184 of user equipment 100. Accordingly, user equipment 100 may interwork even with an application and/or a related server does not support the dynamic graphic user interface. From step S1505, the method advances to step S1506 to test if the APP is inactivated.

When the application not supporting the dynamic graphic user interface is inactivated (Yes—S1506), the default DPI value may be changed to a DPI value of external device 200 at step S1507. Otherwise, the method returns to step S1505 from step S1506 (No—step S1506). An application may be inactivated when the application is terminated or when the application in a foreground transits to a background. Accordingly, user equipment 100, for example application framework 184, may change the default DPI value of user equipment 100 to a DPI value determined according to external device 200. From step S1507, the method advances to step S1508 to test if user equipment 100 is disconnected from the external device. If not disconnected, the method returns to step S1507 from step S1508 (No—step S1508).

Furthermore, when user equipment 100 is disconnected from external device 200 (Yes—step S1508), the DPI value of external device 200 may be changed to a DPI value of user equipment 100 at step S1509. Such an operation may be included in the method of FIG. 9 and FIG. 11. Accordingly, detailed description thereof will be omitted.

As described, two exception handling operations may performed by providing the display unit information of user equipment 100 regardless of whether user equipment 100 is connected to external device 200 or not when an application not supporting the dynamic graphic user interface requests the display unit information and by changing a DPI value of external device 200 back to a default DPI value of user equipment 100 when an application not supporting the dynamic graphic user interface is activated. The present invention, however, is not limited thereto.

Furthermore, when an application or a related server supports the dynamic graphic user interface, user equipment 100 may provide display unit information in various manners. For example, an application may immediately and directly notify change of display unit information to a related server whenever the display unit information is changed because user equipment 100 is connected to external device 200 in accordance with another embodiment of the present invention.

For example, application framework 184 may notify display unit information having a changed DPI value to the server directly or through a corresponding application whenever the DPI value is changed. That is, application framework 184 may notify the change in a DPI value whenever user equipment 100 is connected to or disconnected from external device 200.

As another example, an application may immediately provide current display unit information to the server whenever the application is activated, when the application accesses a related server, and/or when the application in the background mode transits to the foreground mode.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers,

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also he embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling a display setting at user equipment connected to an external device, the method comprising:
displaying image data on a first display unit of the user equipment based on a first display setting;
sensing a connection between the user equipment and the external device;
obtaining display unit information from the external device;
determining a second display setting based on the obtained display unit information;
reconfiguring the image data according to the determined second display setting; and
displaying the reconfigured image data on a second display unit of the external device based on a presence of the sensed connection.

2. The method of claim 1, wherein the determining the second display setting includes:
extracting a screen size and a screen resolution of the second display unit from the obtained display unit information;
selecting a dots per inch (DPI) value from a DPI table based on the extracted screen size and the extracted screen resolution of the second display unit; and
determining the second display setting based on the selected DPI value,
wherein the DPI table includes a plurality of DPI values associated with a plurality of screen sizes and screen resolutions.

3. The method of claim 2, wherein the reconfiguring the image data includes:
determining a screen layout based the selected DPI value included in the second display setting; and
reconfiguring the image data with the determined screen layout.

4. The method of claim 2, wherein the reconfiguring the image data includes:
updating, by an application framework, a default DPI value included in system configuration information with the selected DPI value, wherein the default DPI value is a DPI vale determined for the user equipment before the connection;
notifying, by the application framework, of applications that the system configuration information is updated with the selected DPI value;
determining, by the applications, a screen layout based on the selected DPI value; and
producing the image data, by the applications, with the determined screen layout.

5. The method of claim 1, further comprising:
activating the second display unit of the external device after sensing the connection between the user equipment to the external device;
transmitting the reconfigured image data to external device through the connection between the user equipment and the external device; and
controlling the external device to display the reconfigured image data through the second display unit.

6. The method of 1, further comprising:
sensing an absence of the connection between the user equipment and the external device;
activating the first display unit of the user equipment;
restoring the first display setting; and
displaying the image data on the first display unit based on the restored first display setting.

7. The method of claim 6, wherein the restoring the first display setting includes:
updating, by an application framework, an updated DPI value in system configuration information with a default DPI value, wherein the updated DPI value is a DPI value determined for the external device after the connection and the default DPI value is a DPI value determined for the user equipment before the connection;
notifying, by the application framework, of applications that the system configuration information is updated with the default DPI value;
determining, by the applications, a screen layout based on the default DPI value; and
producing the image data, by the applications, with the determined screen layout.

8. The method of claim 1, wherein:
the first display setting and the second display unit include at least one of a screen size, a screen resolution, a display direction and a DPI value;
the display unit information includes at least one of a manufacturer, a model number, a device identifier (ID), a DPI value, a screen size, screen resolutions, aspect ratios, refresh rates, and response times; and
the reconfiguring the image data includes reconfiguring at least one of the screen size, the screen resolution, the display direction, and the DPI value based on the obtained display unit information.

9. The method of claim 1, further comprising:
receiving a request for display unit information from an application after the connection; and
providing the display unit information of the user equipment.

10. The method of claim 9, wherein the providing the display unit information includes:
determining whether the application dynamically provide a graphic user interface in real time according to the display unit information;
providing the display unit information of the external device when the application dynamically provide a graphic user interface according to the display unit information; and
otherwise, providing the display unit information of the user equipment.

11. The method of claim 1, further comprising:
determining whether an activated application dynamically provides a graphic user interface according to change of a display unit when an application is activated after the sensing a connection between the user equipment and the external device;
maintaining an updated DPI value included in system configuration information when the activated application dynamically provides a graphic user interface according change of a display unit, wherein the updated DPI value is a DPI value determined for the external device after the connection;
changing the updated DPI value included in system configuration information to default DPI value when the activated application does not dynamically provide a graphic interface according to change of a display unit, wherein the default DPI value is a value determined for the user equipment before the connection; and
changing the default DPI value back to the updated. DPI value in the system configuration information when the application becomes inactivated.

12. The method of claim 1, wherein the determining the second display setting includes:
determining e identifier the obtained display unit information of the second display unit;
obtaining a DPI value corresponding to the second display unit based on the determined device ID,
wherein the image data is reconfigured based on a screen layout determined by the obtained DPI value.

13. User equipment for controlling a display setting according to an external device connected to the user equipment, the user equipment comprising:
a first display unit configured to display image data based on a first display setting;
a port unit configured to be connected to the external device, to sense whether the user equipment is connected to the external device, and to generate a connection signal or a disconnection signal based on the sensing result; and
a controller configured to activate the external device when receiving the connection signal from the port unit, to obtain display unit information from the external device, to determine a second display setting based on the obtained display unit information, to reconfigure the image data according to the determined second display setting, to transmit the reconfigured to the external device through the pot unit, and to control the external device to display the reconfigured image data on a second display unit of the external device based on a presence of the sensed connection.

14. The user equipment of claim 13, further comprising:
a memory configured to store a dots per inch (DPI) table including a plurality of DPI values associated with a plurality of screen sizes and screen resolutions,
wherein the controller is configured to:
extract a screen size and a screen resolution of the second display unit from the obtained display unit information;
select a dots per inch (DPI) value from a DPI table based on the extracted screen size and the extracted screen resolution of the second display unit;
determine a screen layout based the selected DPI value; and
reconfigure the image data with the determined screen layout.

15. The user equipment of claim 14, wherein:
the controller is configured to:
update a default DPI value included in system configuration information with the selected DPI value through an application framework., wherein the default DPI value is a DPI vale determined for the user equipment before the user equipment is connected to the external device; and
notify of applications that the system configuration information is updated with the selected DPI value, and
the application determines a screen layout based on the selected DPI value and produces the image data with the determined screen layout.

16. The user equipment of claim 13, wherein:
the controller is configured to:
activate the first display unit upon the receipt of the disconnection signal;
update, through an application framework, an updated DPI value in system configuration information with a default DPI value, wherein the updated DPI value is a DPI value determined for the external device after the connection and the default DPI value is a DPI value determined for the user equipment before the connection;
notify, through the application framework, of applications that the system configuration information is updated with the default DPI value;
receive, from the applications, image data produced with a screen layout based on the default DPI value; and
control the first display unit to display the received image data.

17. The user equipment of claim 13, wherein:
the first display setting and the second display unit include at least one of a screen size, a screen resolution, a display direction and a DPI value;
the display unit information includes at least one of a manufacturer, a model number, a device identifier (ID), a DPI value, a screen size, screen resolutions, aspect ratios, refresh rates, and response times; and
the controller is configured to control at east one of the screen size, the screen resolution, the display direction, and the DPI value based on the obtained display unit information and to display the image data based on the controlled at least one of the screen size, the screen resolution, the display direction, and the DPI value.

18. The user equipment of claim 13, wherein the controller is configured to:
receive a request for display unit information from an application after the user equipment is connected to the external device; and
provide the display unit information of the user equipment to the application through an application framework.

19. The user equipment of claim 18, wherein the controller is configured to:
determine whether the application dynamically provide a graphic user interface in real time according to the display unit information;
provide the display unit information of the external device when the application dynamically provide a graphic user interface according to the display unit information; and
otherwise, provide the display unit information of the user equipment,

20. The user equipment of claim 13, wherein the controller is configured to:
determine whether an activated application dynamically provides a graphic user interface according to change of a display unit when an application is activated after the user equipment is connected to the external device;
maintain an updated DPI value included in system configuration information when the activated application dynamically provides a graphic user interface according to change of a display unit, wherein the updated DPI value is a DPI value determined for the external device after the connection;
change the updated DPI value included in system configuration information to a default DPI value the activated application does not dynamically provide a graphic user interface according to change of a display unit, wherein the default DPI value is a DPI value determined for the user equipment before the connection; and
change the default DPI value back to the updated DPI value in the system configuration info application becomes inactivated.
